(19) United States
(12) Patent Application Publication
(10) Pub. No.: US 2026/0252439 A1
(43) Pub. Date: Aug. 27, 2026

(54) COMMUNICATION SYSTEM AND METHOD AND NON-TRANSITORY COMPUTER READABLE MEDIUM

(71) Applicant: FUJIFILM Business Innovation Corp., Tokyo (JP)

(72) Inventors: Takuto Mikada, Kanagawa (JP); Satomi Kudo, Kanagawa (JP); Hideki Nojo, Kanagawa (JP)

(73) Assignee: FUJIFILM Business Innovation Corp., Tokyo (JP)

(21) Appl. No.: 19/331,774

(22) Filed: Sep. 17, 2025

(30) Foreign Application Priority Data
Feb. 21, 2025 (JP) 2025-027156

(51) Int. Cl. G06F 11/08; H04L 41/06

(52) U.S. Cl. CPC G06F 11/08; H04L 41/06

(57) ABSTRACT

A communication system includes a processor configured to: transmit a data sequence from a first device to a second device via a first communication line that connects the first device and the second device with each other; verify the data sequence stored in a first storage region and the data sequence stored in the second storage region against each other, the data sequence stored in the first storage region being obtained from the first communication line inside the first device, the data sequence stored in the second storage region being received by the second device from the first device via the first communication line and being returned to the first device via a second communication line that connects the first device and the second device with each other; and provide information that a software-related abnormality has occurred in at least one of the first device and the second device if occurrence of an abnormality is detected in communication between the first device and the second device even though the data sequence is stored in the first storage region and in the second storage region within a prescribed time after the data sequence is transmitted to the first communication line and even though the data sequence stored in the first storage region and the data sequence stored in the second storage region are identical to each other in part

### CROSS-REFERENCE TO RELATED APPLICATIONS

This application is based on and claims priority under 35 USC 119 from Japanese Patent Application No. 2025-027156 filed Feb. 21, 2025.

### BACKGROUND

### (i) Technical Field

The present disclosure relates to a communication system and method and a non-transitory computer readable medium.

### (ii) Related Art

Japanese Unexamined Patent Application Publication No. H07-131505 discloses an abnormality detection method for a serial communication line. A device is connected to a process control computer system, and serial communication is used for transmitting and receiving data. A circuit for monitoring the state of a receive data line is added to a receive circuit of a serial communication interface of the process communication computer system, so that the connection state of a device to be connected or a connection cable can be monitored.

Japanese Unexamined Patent Application Publication No. 2000-040986 discloses an abnormality detection apparatus for a communication network. In the communication network, a first communication device and a second communication device are connected to each other via a cable. The abnormality detection apparatus includes a voltage generator and a determiner. The voltage generator generates a first voltage in the first communication device and generates a second voltage in the second communication device. The value of the first voltage and that of the second voltage are different from each other. The determiner monitors a third voltage which is applied to the cable by the voltage generator and determines the state of the communication network based on the value of the third voltage.

Japanese Unexamined Patent Application Publication No. 2021-118445 discloses a communication apparatus that is operated in at least one of a first operation state and a second operation state and performs communication via a communication cable. The power consumption of the communication apparatus in the second operation state is higher than that in the first operation state. The communication apparatus includes a detector that detects the connection state between the communication cable and the communication apparatus. The detector detects the connection state based on at least one of the period of time for which the communication cable is connected to the communication apparatus in the first operation state and the period of time for which the communication cable is disconnected from the communication apparatus in the first operation state.

### SUMMARY

To guarantee the reliability of communication between devices, the occurrence of communication abnormality may be monitored.

In a communication monitoring method of the related art, to detect the occurrence of communication abnormality, data is transmitted regularly or a monitoring circuit is added to a communication device, for example. In such a communication monitoring method, however, it is not possible to detect whether the cause of an abnormality is hardware or software.

Aspects of non-limiting embodiments of the present disclosure relate to a communication system and method and a non-transitory computer readable medium that make it possible to detect, upon the occurrence of abnormality in communication between devices, whether the cause of the abnormality is hardware or software used in the devices.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a communication system including a processor configured to: transmit a data sequence from a first device to a second device via a first communication line that connects the first device and the second device with each other; verify the data sequence stored in a first storage region and the data sequence stored in the second storage region against each other, the data sequence stored in the first storage region being obtained from the first communication line inside the first device, the data sequence stored in the second storage region being received by the second device from the first device via the first communication line and being returned to the first device via a second communication line that connects the first device and the second device with each other; and provide information that a software-related abnormality has occurred in at least one of the first device and the second device if occurrence of an abnormality is detected in communication between the first device and the second device even though the data sequence is stored in the first storage region and in the second storage region within a prescribed time after the data sequence is transmitted to the first communication line and even though the data sequence stored in the first storage region and the data sequence stored in the second storage region are identical to each other.

### BRIEF DESCRIPTION OF THE DRAWINGS

An exemplary embodiment of the present disclosure will be described in detail based on the following figures, wherein:

FIG. 1 is a schematic diagram illustrating the configuration of a communication system;

FIG. 2 is a block diagram illustrating examples of the major elements of the electrical system configuration of an information apparatus;

FIG. 3 is a flowchart illustrating an example of a procedure of communication processing; and

FIG. 4 is a flowchart illustrating a modified example of a procedure of communication processing.

### DETAILED DESCRIPTION

An exemplary embodiment of the disclosure will be described below with reference to the accompanying drawings. In the individual drawings, identical or equivalent elements are designated by like reference numeral and identical or equivalent operations are designated by like step number and an explanation of such an element and an operation will not be repeated. For the sake of representation, the dimensional ratios in the drawings may be exaggerated and be different from the actual ratios.

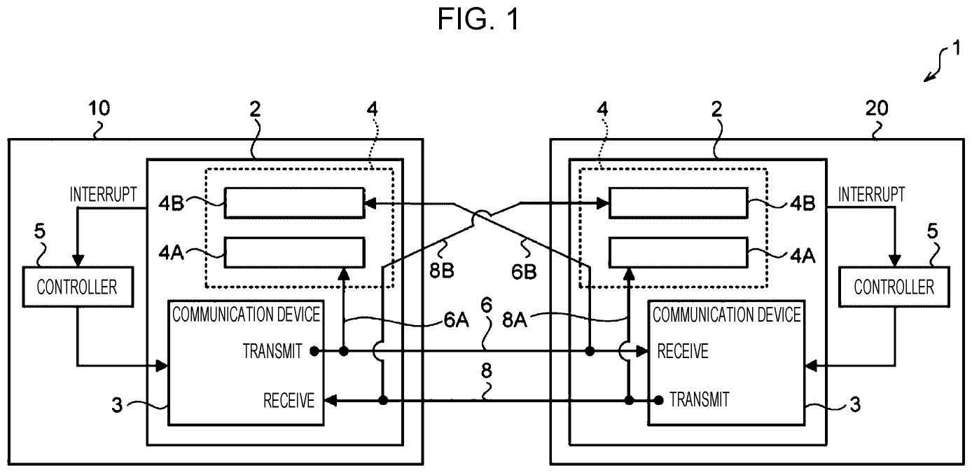

FIG. 1 is a schematic diagram illustrating the configuration of a communication system 1 according to the exemplary embodiment of the disclosure. The communication system 1 includes an information apparatus 10 and an external apparatus 20. The information apparatus 10 is an example of a first device of an exemplary embodiment of the disclosure. The external apparatus 20 is an example of a second device of an exemplary embodiment of the disclosure. The information apparatus 10 and the external apparatus 20 perform data communication with each other. The information apparatus 10 and the external apparatus 20 each includes hardware 2, such as various devices and cables used for data commination, and a controller 5 that controls the hardware 2 to perform data communication.

A communication device 3 forming the hardware 2 is a device that performs serial communication. The communication device 3 thus includes a transmit terminal for transmitting a data sequence and a receive terminal for receiving a data sequence. The transmit terminal of the communication device 3 in the information apparatus 10 is connected to a receive terminal of a communication device 3 in the external apparatus 20 via a cable 6. The receive terminal of the communication device 3 in the information apparatus 10 is connected to a transmit terminal of the communication device 3 in the external apparatus 20 via a cable 8.

The communication device 3 may be any type of device that supports serial communication. Any type of serial communication method may be used. For example, either one of the synchronous serial communication method and the asynchronous serial communication may be employed. As the serial communication protocol handled by the communication device 3, any type of protocol may be used.

The hardware 2 also includes a connection detection module 4. The connection detection module 4 includes a first buffer 4A and a second buffer 4B.

The first buffer 4A is a storage region storing a data sequence transmitted by the communication device 3, which forms the information apparatus 10 including the first buffer 4A. The first buffer 4A is connected to the cable 6, which is used for transmitting a data sequence from the communication device 3 of the information apparatus 10, via an internal cable 6A inside the information apparatus 10. The internal cable 6A is an element forming the hardware 2 in the information apparatus 10. Every time the information apparatus 10 transmits a data sequence to the external apparatus 20, the data sequence transmitted by the communication device 3 of the information apparatus 10 is stored in the first buffer 4A of the information apparatus 10 via the internal cable 6A.

Inside the external apparatus 20, which is a data communication party of the information apparatus 10, one end of a cable 6B is connected to the cable 6. The other end of the cable 6B is connected to the second buffer 4B of the information apparatus 10. Every time the information apparatus 10 transmits a data sequence to the external apparatus 20, the data sequence received by the external apparatus 20 from the information apparatus 10 via the cable 6 loops back to the information apparatus 10 via the cable 6B. The data sequence returned from the external apparatus 20 is stored in the second buffer 4B of the information apparatus 10. That is, the external apparatus 20 returns a data sequence received from the information apparatus 10 via the cable 6 to the information apparatus 10 via the cable 6B. As a result, the data sequence received by the external apparatus 20 from the information apparatus 10 is stored in the second buffer 4B.

Likewise, a first buffer 4A in the external apparatus 20 is connected to the cable 8, which is used for transmitting a data sequence from the communication device 3 of the external apparatus 20, via an internal cable 8A inside the external apparatus 20. The internal cable 8A is an element forming the hardware 2 in the external apparatus 20. Every time the external apparatus 20 transmits a data sequence to the information apparatus 10, the data sequence transmitted by the communication device 3 of the external apparatus 20 is stored in the first buffer 4A of the external apparatus 20 via the internal cable 8A.

Inside the information apparatus 10, which is a data communication party of the external apparatus 20, one end of a cable 8B is connected to the cable 8. The other end of the cable 8B is connected to a second buffer 4B of the external apparatus 20. Every time the external apparatus 20 transmits a data sequence to the information apparatus 10, the data sequence received by the information apparatus 10 from the external apparatus 20 via the cable 8 loops back to the external apparatus 20 via the cable 8B. The data sequence returned from the information apparatus 10 is stored in the second buffer 4B of the external apparatus 20. That is, the information apparatus 10 returns a data sequence received from the external apparatus 20 via the cable 8 to the external apparatus 20 via the cable 8B. As a result, the data sequence received by the information apparatus 10 from the external apparatus 20 is stored in the second buffer 4B of the external apparatus 20.

In this manner, a data sequence to be transmitted from the information apparatus 10 to the external apparatus 20 is turned back inside the information apparatus 10 and is stored in the first buffer 4A of the information apparatus 10, while a data sequence to be transmitted from the external apparatus 20 to the information apparatus 10 is turned back inside the external apparatus 20 and is stored in the first buffer 4A of the external apparatus 20. In contrast, a data sequence received by the external apparatus 20 is turned back inside the external apparatus 20 and is stored in the second buffer 4B of the information apparatus 10, while a data sequence received by the information apparatus 10 is turned back inside the information apparatus 10 and is stored in the second buffer 4B of the external apparatus 20. The data sequence stored in each of the first buffer 4A and the second buffer 4B is deleted by the storage of a new data sequence.

The connection detection module 4 generates an interrupt every time a data sequence is stored in both of the first buffer 4A and the second buffer 4B. An interrupt is generated by the connection detection module 4 only through the hardware 2. That is, if a condition for generating an interrupt is satisfied in a state in which the apparatus is ON, the connection detection module 4 generates an interrupt without the intervention of software. The occurrence of an interrupt is notified to the controller 5.

The controller 5 executes communication processing based on an instruction from a user, the storage state of the first buffer 4A and the second buffer 4B, and the content represented by a data sequence received from a communication party, for example.

When performing data communication, for example, the controller 5 controls the hardware 2 to execute communication processing. For instance, when the controller 5 of the information apparatus 10 receives an interrupt from the connection detection module 4, it verifies the data sequence stored in the first buffer 4A in the information apparatus 10 and that in the second buffer 4B in the information apparatus 10 against each other and executes communication processing in accordance with the verification result. The controller 5 also determines whether a data sequence is stored in each of the first buffer 4A and the second buffer 4B of the information apparatus 10 within a prescribed time after the data sequence is transmitted, and executes communication processing in accordance with the determination result. The controller 5 of the external apparatus 20 executes communication processing similarly to that of the information apparatus 10.

The above-described communication processing of the controller 5 is executed by software. That is, communication processing executed in each of the information apparatus 10 and the external apparatus 20 is implemented by the collaborative operation of software and the hardware 2. Details of communication processing executed by the controller 5 will be discussed later.

Data communication in the communication system 1 will be explained as viewed from the information apparatus 10. The cable 6 will thus be called “transmit cable 6”. The cable 8 is used for receiving a data sequence from the external apparatus 20 as viewed from the information apparatus 10. The cable 8 will thus be called “receive cable 8”. The receive cable 8 is also used for transmitting a data sequence to the information apparatus 10 as viewed from the external apparatus 20, and it may also be called “transmit cable 8” depending on the situation. The transmit cable 6 and the receive cable 8 (or transmit cable 8) is an example of a first communication line in an exemplary embodiment of the disclosure.

The cable 6B will be called “loopback cable 6B”, while the cable 8B will be called “loopback cable 8B”. Each of the loopback cables 6B and 8B is an example of a second communication line in an exemplary embodiment of the disclosure.

The purpose of use of the information apparatus 10 and the external apparatus 20 is not limited to a specific purpose if the information apparatus 10 and the external apparatus 20 each include the controller 5 executing communication processing and the hardware 2 configured as shown in FIG. 1. The information apparatus 10 may be an image forming device having multiple functions, such as a copy function and a scan function. The image forming device transmits various items of information to a server (not shown) so that the server can remotely diagnose the operation state of the image forming device, for example. The information apparatus 10 may be a telemeter that regularly transmits measurement data on the rainfall and the river water level, for example, to a server. In this case, the external apparatus 20 corresponds to the server.

The information apparatus 10 in the communication system 1 is constituted by a computer.

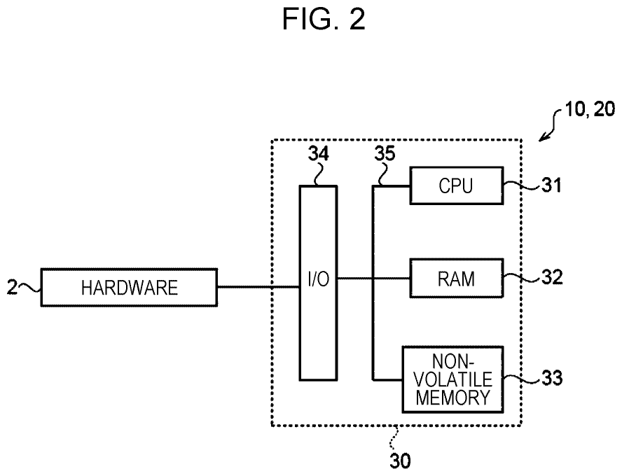

FIG. 2 is a block diagram illustrating examples of the major elements of the electrical system configuration of the information apparatus 10 constituted by a computer 30.

The computer 30 forming the information apparatus 10 includes a central processing unit (CPU) 31, a random access memory (RAM) 32, a non-volatile memory 33, and an input/output interface (I/O) 34. The CPU 31 is an example of a processor that executes processing of the controller 5. The RAM 32 is used as a temporary work area for the CPU 31. The CPU 31, RAM 32, non-volatile memory 33, and I/O 34 are connected to each other via a bus 35.

The non-volatile memory 33 is an example of a storage device that can retrieve stored information even after power supplied to the non-volatile memory 33 is interrupted. As the non-volatile memory 33, a semiconductor memory, for example, is used, or a hard disk may alternatively be used. In the non-volatile memory 33, information that needs to be retained even after power supplied to the information apparatus 10 is interrupted, such as a communication program that allows the computer 30 to function as the information apparatus 10, is stored.

The hardware 2, for example, is connected to the I/O 34. The CPU 31 controls the hardware 2 via the I/O 34. Units and devices connected to the I/O 34 vary in accordance with the purpose of use of the information apparatus 10. For example, if the information apparatus 10 is an image forming device, an image forming unit and a scanner unit are connected to the I/O 34. The image forming unit forms an image based on image data on a recording medium, such as a sheet, in accordance with an instruction from the CPU 31. The scanner unit optically reads the content of a document and converts the read content of the document into image data in accordance with an instruction from the CPU 31.

As in the information apparatus 10, the external apparatus 20 is also constituted by a computer 30 such as that configured as shown in FIG. 2, though an explanation thereof will not be given.

A description will be given of the approach to determining the cause of the occurrence of abnormality in data communication in the communication system 1 through an illustration of an example in which a data sequence is transmitted from the information apparatus 10 to the external apparatus 20.

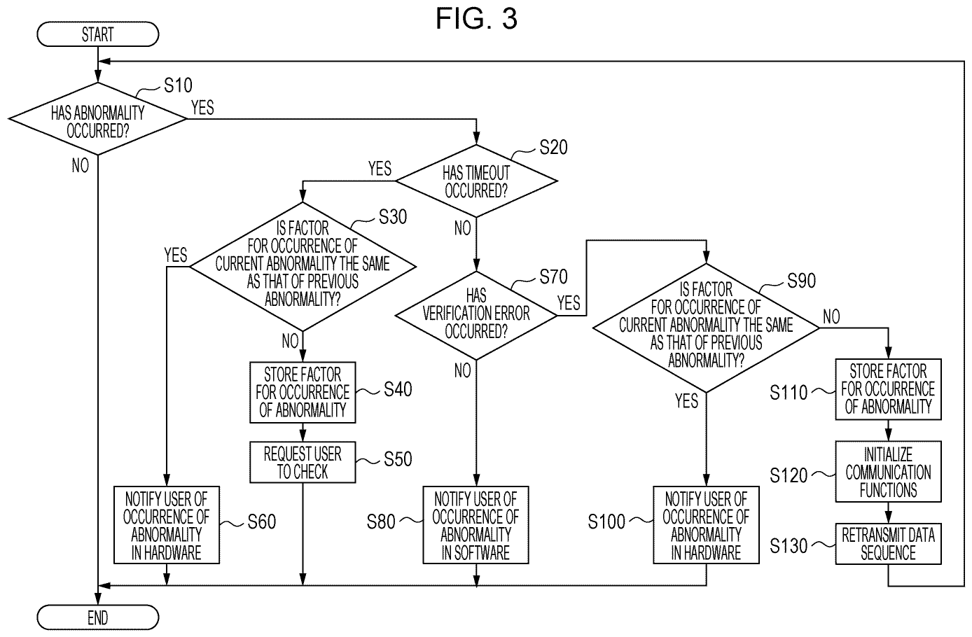

FIG. 3 is a flowchart illustrating an example of a procedure of communication processing executed by the controller 5 of the information apparatus 10 when the communication device 3 transmits a data sequence to the external apparatus 20 under the control of the controller 5.

The communication program describing communication processing is prestored in the non-volatile memory 33 of the information apparatus 10, for example. The CPU 31, which functions as the controller 5 of the information apparatus 10, reads the communication program stored in the non-volatile memory 33 and executes communication processing.

A data sequence transmitted by the communication device 3 to the external apparatus 20 under the control of the CPU 31 of the information apparatus 10 reaches the external apparatus 20 via the transmit cable 6. The CPU 31 starts a timer every time a data sequence is transmitted. The prescribed time to be measured by the timer is set to a time that can guarantee that a data sequence has reached the external apparatus 20 if the time from when the data sequence is transmitted until it is stored in the second buffer 4B of the information apparatus 10 is lower than or equal to the prescribed time.

As discussed above, when a data sequence is stored in the first buffer 4A and the second buffer 4B, the connection detection module 4 generates an interrupt and notifies the CPU 31 of the occurrence of the interrupt. When communication is executing regularly, the CPU 31 is supposed to receive an interrupt from the connection detection module 4 within the prescribed time. When the CPU 31 receives an interrupt from the connection detection module 4, it stops the timer.

In contrast, if a data sequence is not stored in at least one of the first buffer 4A and the second buffer 4B and the CPU 31 does not receive an interrupt from the connection detection module 4, the timer times out after the lapse of the prescribed time. When the timer has timed out, the occurrence of timeout is notified to the CPU 31. That is, notifying the CPU 31 of the occurrence of timeout means notifying the CPU 31 of the occurrence of abnormality in data communication. The prescribed time that represents the maximum tolerable time from when a data sequence is transmitted until when an interrupt is received from the connection detection module 4 is prestored in the non-volatile memory 33, for example.

As explained above, when the CPU 31 has received an interrupt from the connection detection module 4, it verifies the data sequence stored in the first buffer 4A and that in the second buffer 4B against each other. By executing this verification processing, the CPU 31 determines whether the data sequence stored in the first buffer 4A and that in the second buffer 4B are the same data sequence. When data communication is executing properly, the same data sequence is stored in the first buffer 4A and the second buffer 4B. Accordingly, when the data sequence stored in the first buffer 4A and that in the second buffer 4B are different, the CPU 31 determines that a verification error has occurred.

There may be a case in which one apparatus transmits a command to the other apparatus. In this case, if the apparatus transmits a nonstandard command or if the other apparatus does not return a standard response to the command, it means that an abnormality has occurred in data communication.

In the information apparatus 10, the controller 5 monitors the occurrence of such abnormality in data communication. The controller 5 stores the factors for the occurrence of abnormality in the non-volatile memory 33 in chronological order.

In step S10, the CPU 31 determines whether an abnormality has occurred in transmission of a data sequence. If no abnormality has occurred, it means that a data sequence has successfully reached the external apparatus 20, and the CPU 31 terminates the communication processing shown in FIG. 3. If an abnormality has occurred, the CPU 31 proceeds to step S20.

In step S20, the CPU 31 determines whether a timeout has occurred to receive an interrupt from the connection detection module 4. In the case of the occurrence of a timeout, the CPU 31 proceeds to step S30.

In step S30, the CPU 31 determines whether the factor for the occurrence of the current abnormality is the same as that for the occurrence of the previous abnormality. That is, the CPU 31 determines whether a timeout has also occurred to receive an interrupt from the connection detection module 4 in the previous data communication between the information apparatus 10 and the external apparatus 20. Logs of data communication between the information apparatus 10 and the external apparatus 20 are stored in the non-volatile memory 33. If the factor for the occurrence of the previous abnormality is not a timeout, the CPU 31 proceeds to step S40.

In step S40, the CPU 31 stores the factor for the occurrence of the current abnormality, that is, the occurrence of timeout to receive an interrupt from the connection detection module 4, in the non-volatile memory 33.

If a timeout has occurred in the current data communication even though a timeout to receive an interrupt from the connection detection module 4 has not occurred in the previous data communication, at least one of the transmit cable 6 and the loopback cable 6B may be disconnected, or the external apparatus 20 may have stopped operating for some reason. Disconnection of the transmit cable 6 and/or the loopback cable 6B in an exemplary embodiment of the disclosure includes a situation where the transmit cable 6 and the loopback cable 6B are disconnected from a connector.

In step S50, the CPU 31 requests a user to check whether at least one of the transmit cable 6 and the loopback cable 6B is disconnected or whether the external apparatus 20 is operating properly. Then, the CPU 31 finishes the communication processing in FIG. 3. This can make the user check the transmit cable 6 and the loopback cable 6B and also check the operating state of the external apparatus 20. After finishing checking, the user instructs the CPU 31 to retransmit the data sequence.

The CPU 31 requests the user to do the above-described checking by displaying the request on a display unit (not shown) of the information apparatus 10 or by outputting the request as sound from a speaker (not shown) of the information apparatus 10. If the information apparatus 10 is connected to a server via a local area network (LAN), the CPU 31 may cause the server to send the request to the user.

If it is determined in step S30 that the factor for the occurrence of the current abnormality is the same as that for the occurrence of the previous abnormality, the CPU 31 proceeds to step S60. This means that a timeout has occurred again to receive an interrupt from the connection detection module 4 even though the CPU 31 has requested the user to check the transmit cable 6 and the loopback cable 6B and to check the operating state of the external apparatus 20 in step S50. Hence, the cause of the occurrence of timeout is likely to be a failure related to the hardware 2.

In step S60, the CPU 31 thus notifies the user of the occurrence of abnormality in at least one of the hardware 2 of the information apparatus 10 and that of the external apparatus 20. The CPU 31 then finishes the communication processing in FIG. 3.

In this manner, when a timeout has occurred to receive an interrupt from the connection detection module 4, the CPU 31 narrows down the possible factors for the occurrence of abnormality to three. The three factors are: the abnormality in the hardware 2 of the information apparatus 10, disconnection of at least one of the transmit cable 6 and the loopback cable 6B, and malfunctioning of the external apparatus 20.

If it is determined in step S20 that a timeout has not occurred to receive an interrupt from the connection detection module 4, the CPU 31 proceeds to step S70.

In step S70, the CPU 31 determines whether a verification error has occurred. If no verification error has occurred, the CPU 31 proceeds to step S80.

This means that the abnormality has occurred in data communication even though neither of a timeout to receive an interrupt from the connection detection module 4 nor a verification error has occurred. That is, data communication is executing properly in the hardware 2, which functions as the physical layer in the network hierarchy. The cause of the occurrence of abnormality is thus likely to be software.

In step S80, the CPU 31 thus notifies the user that an abnormality has occurred in at least one of software of the information apparatus 10 and that of the external apparatus 20. The CPU 31 then finishes the communication processing in FIG. 3.

If it is determined in step S70 that a verification error has occurred, the CPU 31 proceeds to step S90.

In step S90, the CPU 31 determines whether the cause of the current abnormality is the same as that in the previous data communication. That is, the CPU 31 determines whether a verification error has also occurred in the previous data communication between the information apparatus 10 and the external apparatus 20. If the factor for the occurrence of the abnormality in the previous data communication is not a verification error, the CPU 31 proceeds to step S110.

In step S110, the CPU 31 stores the factor for the occurrence of the current abnormality, that is, the occurrence of verification error, in the non-volatile memory 33.

One of the causes of the occurrence of verification error may be noise, for example. In most cases, noise suddenly occurs rather than continuously. If the occurrence of noise has abated, data communication may be performed properly.

In step S120, the CPU 31 initializes the communication functions of the information apparatus 10. Initializing the communication functions includes resetting of the hardware 2 and re-executing of software for the communication functions, for example. The communication functions can be reconstructed by initialization.

After the communication functions are reconstructed, in step S130, the CPU 31 retransmits the same data sequence as that in which the verification error has occurred. After retransmitting the data sequence, the CPU 31 returns to step S10 to redetermine whether an abnormality has occurred in this data sequence.

If it is determined in step S90 that a verification error has also occurred in the previous data communication, the CPU 31 proceeds to step S100.

Storing of a data sequence in the first buffer 4A and the second buffer 4B is executed only by the hardware 2 without the intervention of software.

If a verification error has occurred again even though the communication functions are initialized due to the occurrence of a verification error in the previous data communication and software for the communication functions is re-executed, it means that an abnormality has occurred in the hardware 2.

In step S100, the CPU 31 thus notifies the user that an abnormality has occurred in at least one of the hardware 2 of the information apparatus 10 and that of the external apparatus 20. The CPU 31 then finishes the communication processing in FIG. 3.

As described above, the communication system 1 of an exemplary embodiment of the disclosure includes, as the hardware 2, the connection detection module 4 and the cables 6B and 8B through which a data sequence having reached a communication party loops back to the apparatus that has transmitted the data sequence. The communication system 1 determines whether the hardware 2 or software is the cause of the occurrence of an abnormality, based on a combination of determination results regarding: whether a timeout has occurred, whether a verification error of a data sequence in the connection detection module 4 has occurred, and whether the abnormality has continuously occurred by the same factor.

### Modified Examples of Communication Processing

In the communication processing shown in FIG. 3, if it is determined in step S90 that a verification error has also occurred in the previous data communication, a user is notified of the occurrence of an abnormality in the hardware 2. If the factor for the occurrence of the abnormality in the previous data communication is not a verification error, it is determined that the cause of the occurrence of verification error in the current data communication is likely to be noise. Nevertheless, noise may occur every time a data sequence is transmitted, in which case, verification errors may occur continuously. In the communication processing of a modified example, therefore, when verification errors have occurred continuously, it is more precisely determined whether the cause of the occurrence of abnormality is software or the hardware 2 than in the communication processing in FIG. 3.

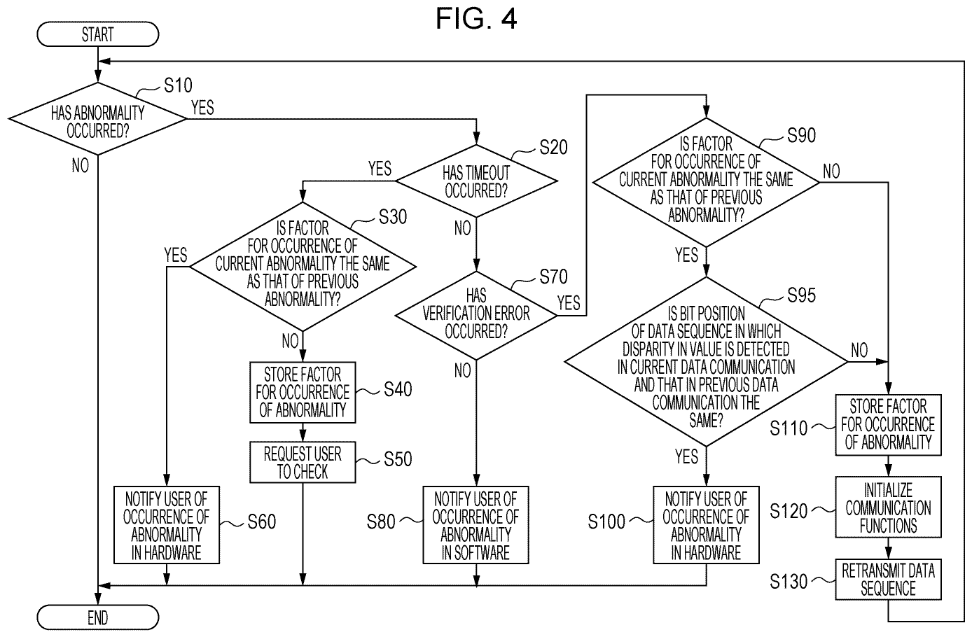

FIG. 4 is a flowchart illustrating a modified example of a procedure of communication processing executed by the controller 5 of the information apparatus 10 when the communication device 3 transmits a data sequence to the external apparatus 20 under the control of the controller 5. The communication processing in FIG. 4 is different from that in FIG. 3 in that step S95 is added. The other operations are the same as those in FIG. 3. The modified example will thus be explained while mainly referring to step S95.

If it is determined in step S90 that a verification error has also occurred in the previous data communication, the CPU 31 proceeds to step S95.

The position of a data sequence in which noise occurs is not the same, and the strength of noise is not the same, either. If verification errors have occurred continuously due to noise, the bit position of a data sequence in which the disparity in the value is detected tends to be different every time a verification error occurs.

Accordingly, in step S95, the CPU 31 determines whether the bit position of the data sequence in which the disparity in the value is detected in the current data communication and that in the previous data communication are the same. When a verification error occurs in a data sequence due to noise, the bit position of the data sequence in which the disparity in the value is detected tends to be different between a verification error in the current data communication and that in the previous data communication. If the bit position of the data sequence in which the disparity in the value is detected in the current data communication and that in the previous data communication are the same, it means that the abnormality has occurred in the hardware 2. The CPU 31 thus proceeds to step S100.

In contrast, if it is determined in step S95 that the bit position of the data sequence in which the disparity in the value is detected in the current data communication and that in the previous data communication are different from each other, the factor for the occurrence of the verification error is likely to be noise. The CPU 31 thus proceeds to step S110 and retransmits the data sequence in step S130. If an abnormality occurs in the retransmitted data sequence, the CPU 31 detects whether the cause of the abnormality is the hardware 2 or software, based on the factor for the occurrence of the abnormality. When the factor for the occurrence of abnormality, that is, the occurrence of verification error, is stored in the non-volatile memory 33 in step S110 in FIG. 4, the CPU 31 also stores the bit position of the data sequence in which the disparity in the value is detected.

As described above, in the communication system 1 of an exemplary embodiment of the disclosure, when verification errors have occurred continuously, the cause of the abnormality, that is, whether it is the hardware 2 or software, is determined more precisely than in the communication processing in FIG. 3, based on a change in the bit position of a data sequence in which the disparity in the value is detected.

In the communication processing in FIG. 4, for a data sequence retransmitted due to the occurrence of verification error, if verification errors occur continuously and if the bit position of the data sequence in which the disparity in the value is detected is changed every time the data sequence is retransmitted, the data sequence continues to be retransmitted. Given that, however, noise occurs abruptly in most cases, if the cause of a verification error is noise, the data sequence is to be transmitted successfully after it is retransmitted several times. Hence, after it is determined in step S95 that the bit position of the data sequence in which the disparity in the value is detected in the current data communication and that in the previous data communication are different from each other, the CPU 31 may execute step S110 if the number of retransmission times of the data sequence is found to be smaller than or equal to a prescribed number. If the number of retransmission times of the data sequence exceeds the prescribed number, the cause of the verification error is highly likely to be the hardware 2 rather than noise. In this case, the CPU 31 may proceed to step S100 and notify the user of the occurrence of abnormality in at least one of the hardware 2 of the information apparatus 10 and that of the external apparatus 20.

The above-described communication processing has been discussed through illustration of data communication executed in the communication system 1 as viewed from the information apparatus 10. However, the content of the disclosure is also applicable to the external apparatus 20, which is the communication party of the information apparatus 10. If communication processing is executed in the communication system 1 as viewed from the external apparatus 20, in the above-described explanation given with reference to FIGS. 3 and 4, the information apparatus 10 can be read as the external apparatus 20, the external apparatus 20 can be read as the information apparatus 10, the transmit cable 6 can be read as the transmit cable 8, and the loopback cable 6B can be read as the loopback cable 8B.

An aspect of the communication system 1 has been discussed through illustration of the exemplary embodiment, but it is only an example. The mode of the communication system 1 is not limited to that in the exemplary embodiment. Various modifications and/or improvements may be made to the exemplary embodiment without departing from the spirit and scope of the disclosure. Exemplary embodiments obtained by making modifications and/or improvements are also encompassed within the technical range of the disclosure. For example, the order of steps in the communication processing in each of FIGS. 3 and 4 may be changed without departing from the spirit and scope of the disclosure.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content. The program of an exemplary embodiment of the disclosure may be provided as a program product.

Each of the information apparatus 10 and the external apparatus 20 may download the communication program and store it in the non-volatile memory 33.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A communication system comprising:
a processor configured to:
   transmit a data sequence from a first device to a second device via a first communication line that connects the first device and the second device with each other;
   verify the data sequence stored in a first storage region and the data sequence stored in the second storage region against each other, the data sequence stored in the first storage region being obtained from the first communication line inside the first device, the data sequence stored in the second storage region being received by the second device from the first device via the first communication line and being returned to the first device via a second communication line that connects the first device and the second device with each other; and
   provide information that a software-related abnormality has occurred in at least one of the first device and the second device if occurrence of an abnormality is detected in communication between the first device and the second device even though the data sequence is stored in the first storage region and in the second storage region within a prescribed time after the data sequence is transmitted to the first communication line and even though the data sequence stored in the first storage region and the data sequence stored in the second storage region are identical to each other.
(((2)))

The communication system according to (((1))), wherein the processor is configured to provide information, if the data sequence is not stored in at least one of the first storage region and the second storage region after a lapse of the prescribed time, that a hardware-related abnormality has occurred in at least one of the first device and the second device; at least one of the first communication line and the second communication line is disconnected; or the second device is not operating.
(((3)))

The communication system according to (((2))), wherein the processor is configured to provide a request to check whether at least one of the first communication line and the second communication line is disconnected or whether the second device is operating if the data sequence is not stored in at least one of the first storage region and the second storage region after the lapse of the prescribed time even though the data sequence has been previously stored in the first storage region and in the second storage region within the prescribed time.
(((4)))

The communication system according to (((3))), wherein the processor is configured to provide information that a hardware-related abnormality has occurred in at least one of the first device and the second device if the data sequence, which has been retransmitted from the first device to the second device after the processor has provided information that at least one of the first communication line and the second communication line is disconnected or the second device is not operating, is still not stored in at least one of the first storage region and the second storage region even after the lapse of the prescribed time.
(((5)))

The communication system according to one of (((1))) to (((4))), wherein the processor is configured to initialize a communication function of the first device and a communication function of the second device if the data sequence is stored in the first storage region and in the second storage region within the prescribed time but if the data sequence stored in the first storage region and the data sequence stored in the second storage region are different from each other even though the data sequence has been previously stored in the first storage region and in the second storage region within the prescribed time and the data sequence stored in the first storage region and the data sequence stored in the second storage region have been previously identical to each other.
(((6)))

The communication system according to (((5))), wherein the processor is configured to provide information that a hardware-related abnormality has occurred in at least one of the first device and the second device if the data sequence, which has been retransmitted from the first device to the second device after the communication function of the first device and the communication function of the second device are initialized, is stored in the first storage region and in the second storage region within the prescribed time but if the data sequence stored in the first storage region and the data sequence stored in the second storage region are still different from each other.
(((7)))

A communication program causing a computer to execute a process comprising:
transmitting a data sequence from a first device to a second device via a first communication line that connects the first device and the second device with each other;
verifying the data sequence stored in a first storage region and the data sequence stored in the second storage region against each other, the data sequence stored in the first storage region being obtained from the first communication line inside the first device, the data sequence stored in the second storage region being received by the second device from the first device via the first communication line and being returned to the first device via a second communication line that connects the first device and the second device with each other; and
providing information that a software-related abnormality has occurred in at least one of the first device and the second device if occurrence of an abnormality is detected in communication between the first device and the second device even though the data sequence is stored in the first storage region and in the second storage region within a prescribed time after the data sequence is transmitted to the first communication line and even though the data sequence stored in the first storage region and the data sequence stored in the second storage region are identical to each other.

What is claimed is:

1. A communication system comprising:
a processor configured to:
transmit a data sequence from a first device to a second device via a first communication line that connects the first device and the second device with each other;
verify the data sequence stored in a first storage region and the data sequence stored in the second storage region against each other, the data sequence stored in the first storage region being obtained from the first communication line inside the first device, the data sequence stored in the second storage region being received by the second device from the first device via the first communication line and being returned to the first device via a second communication line that connects the first device and the second device with each other; and
provide information that a software-related abnormality has occurred in at least one of the first device and the second device if occurrence of an abnormality is detected in communication between the first device and the second device even though the data sequence is stored in the first storage region and in the second storage region within a prescribed time after the data sequence is transmitted to the first communication line and even though the data sequence stored in the first storage region and the data sequence stored in the second storage region are identical to each other.

2. The communication system according to claim 1, wherein the processor is configured to provide information, if the data sequence is not stored in at least one of the first storage region and the second storage region after a lapse of the prescribed time, that a hardware-related abnormality has occurred in at least one of the first device and the second device; at least one of the first communication line and the second communication line is disconnected; or the second device is not operating.

3. The communication system according to claim 2, wherein the processor is configured to provide a request to check whether at least one of the first communication line and the second communication line is disconnected or whether the second device is operating if the data sequence is not stored in at least one of the first storage region and the second storage region after the lapse of the prescribed time even though the data sequence has been previously stored in the first storage region and in the second storage region within the prescribed time.

4. The communication system according to claim 3, wherein the processor is configured to provide information that a hardware-related abnormality has occurred in at least one of the first device and the second device if the data sequence, which has been retransmitted from the first device to the second device after the processor has provided information that at least one of the first communication line and the second communication line is disconnected or the second device is not operating, is still not stored in at least one of the first storage region and the second storage region even after the lapse of the prescribed time.

5. The communication system according to claim 1, wherein the processor is configured to initialize a communication function of the first device and a communication function of the second device if the data sequence is stored in the first storage region and in the second storage region within the prescribed time but if the data sequence stored in the first storage region and the data sequence stored in the second storage region are different from each other even though the data sequence has been previously stored in the first storage region and in the second storage region within the prescribed time and the data sequence stored in the first storage region and the data sequence stored in the second storage region have been previously identical to each other.

6. The communication system according to claim 5, wherein the processor is configured to provide information that a hardware-related abnormality has occurred in at least one of the first device and the second device if the data sequence, which has been retransmitted from the first device to the second device after the communication function of the first device and the communication function of the second device are initialized, is stored in the first storage region and in the second storage region within the prescribed time but if the data sequence stored in the first storage region and the data sequence stored in the second storage region are still different from each other.

7. A communication method comprising:
transmitting a data sequence from a first device to a second device via a first communication line that connects the first device and the second device with each other;
verifying the data sequence stored in a first storage region and the data sequence stored in the second storage region against each other, the data sequence stored in the first storage region being obtained from the first communication line inside the first device, the data sequence stored in the second storage region being received by the second device from the first device via the first communication line and being returned to the first device via a second communication line that connects the first device and the second device with each other; and
providing information that a software-related abnormality has occurred in at least one of the first device and the second device if occurrence of an abnormality is detected in communication between the first device and the second device even though the data sequence is stored in the first storage region and in the second storage region within a prescribed time after the data sequence is transmitted to the first communication line and even though the data sequence stored in the first storage region and the data sequence stored in the second storage region are identical to each other.

8. A non-transitory computer readable medium storing a program causing a computer to execute a process comprising:
transmitting a data sequence from a first device to a second device via a first communication line that connects the first device and the second device with each other;
verifying the data sequence stored in a first storage region and the data sequence stored in the second storage region against each other, the data sequence stored in the first storage region being obtained from the first communication line inside the first device, the data sequence stored in the second storage region being received by the second device from the first device via the first communication line and being returned to the first device via a second communication line that connects the first device and the second device with each other; and
providing information that a software-related abnormality has occurred in at least one of the first device and the second device if occurrence of an abnormality is detected in communication between the first device and the second device even though the data sequence is stored in the first storage region and in the second storage region within a prescribed time after the data sequence is transmitted to the first communication line and even though the data sequence stored in the first storage region and the data sequence stored in the second storage region are identical to each other.
